(19) United States
(12) Patent Application Publication
(10) Pub. No.: US 2025/0117547 A1
(43) Pub. Date: Apr. 10, 2025

(54) OPTIMIZATION METHOD FOR LAYERING SCHEME OF MULTILAYER INJECTION MOLDING

(71) Applicant: ZHEJIANG UNIVERSITY, Hangzhou City (CN)

(72) Inventors: Peng ZHAO, Hangzhou City (CN); Ruoxiang GAO, Hangzhou City (CN); Hao CHEN, Hangzhou City (CN); Yong XU, Hangzhou City (CN); Yuhong CHEN, Hangzhou City (CN); Jianzhong FU, Hangzhou City (CN)

(73) Assignee: ZHEJIANG UNIVERSITY, Hangzhou City (CN)

(21) Appl. No.: 18/903,527

(22) Filed: Oct. 1, 2024

(30) Foreign Application Priority Data
Oct. 7, 2023 (CN) 202311284857.6

(51) Int. Cl. G06F 30/23; B29C 45/76; G06F 119/18

(52) U.S. Cl. CPC G06F 30/23; B29C 45/76; G06F 2119/18

(57) ABSTRACT

An optimization method for a layering scheme of multilayer injection molding, including: solving a heat transfer equation by using a finite difference method to obtain a cooling time for injection of each layer under different layering schemes, and obtaining a relationship model of a cooling time of a single layer and a layering scheme by fitting; and finally, with an objective of minimizing cooling times of all injection layers and a constraint condition of a total thickness of a product, optimizing a particular layering scheme by using a Lagrange multiplier method. Through optimization by the method, an optimized layering scheme can be obtained, allowing for an effectively shortened injection molding cycle, a reduced production cost, and improved product quality.

### CROSS REFERENCE TO RELATED APPLICATIONS

This application claims foreign priority benefits under 35 U.S.C. § 119(a)-(d) to Chinese Patent Application No. 202311284857.6, filed on Oct. 7, 2023, the disclosure of which is hereby incorporated herein by reference in its entirety.

### TECHNICAL FIELD

The present disclosure belongs to the technical field of injection molding, and in particular, to an optimization method for a layering scheme of multilayer injection molding.

### BACKGROUND

During injection molding, a production cycle of a product is the most concerned problem for an enterprise. A cooling stage is the one accounting for the biggest part of an overall cycle, which directly decides the time of the whole production period. The optimization of the cooling time may help improve the production efficiency and shorten the time of the production cycle. By reasonably setting the cooling time, the production cycle can be reduced to the utmost extent, and the production efficiency and yield can be increased. Studies have shown that for an ordinary flat plate, a direction of heat flow is mainly a thickness direction, and a cooling process thereof may be regarded as a one-dimensional unsteady heat conduction problem, ultimately resulting in the cooling time is in direct proportion to the square of a product thickness. Therefore, in traditional injection molding production, the cooling time is usually set according to experience. That is, the cooling time is estimated according to a maximum wall thickness of the product.

In recent years, with the development of high-end manufacturing, the demand for thick-walled polymer injection-molded products is gradually increasing. When a thick-walled product is molded by conventional injection molding, defects such as shrinkage and bubbles are prone to occurring which cannot meet the molding requirements. Multilayer injection molding is achieved by continuous injection layer by layer, where a solidified product from previous injection is used as an insert for each next injection, and finally thick-walled polymer molding is converted into layer-by-layer sequentially molding of thin-walled products. The cooling time of a multilayer injection-molded product is related to both of a thickness of a current injection layer and a thickness of a solidified part. The heat conduction form of traditional single injection molding is no longer suitable. However, at present, there is still no specific solution for setting the cooling time in the field of multilayer injection molding.

Some researchers have conducted experimental studies on a layering scheme for multilayer injection-molded product, which determine a number of layers and a thickness of each layer for a particular product. Maier et al. had conducted experimental studies on the influences of three layering schemes different in injection order, direction, and thickness on a production cycle. Results indicated that molding a core layer before a surface layer, with a relatively larger core layer thickness could reduce the production cycle to the utmost extent. The research results of Hopmann et al. also demonstrated that the layering sequence of molding a core layer before a surface layer could significantly reduce a product molding cycle. However, existing studies are only focused on products with a small number of layers, and are intended to explore an optimal layering scheme through experiments by exhausting different layering schemes. For thick-walled products with a large number of layers, such an experimental method will greatly increase a research cost. Therefore, there is an urgent need for an optimization method for a layering scheme of multilayer injection molding.

### SUMMARY

To solve the problems in the prior art, the present disclosure provides an optimization method for a layering scheme of multilayer injection molding. The method avoids the problems of low accuracy, high trial and error cost caused by setting a cooling time and a layering scheme for multilayer injection molding laying on experience.

An optimization method for a layering scheme of multilayer injection molding includes the following steps:
(1) inputting a product size, a thermal diffusion coefficient of a material, a plurality of layering schemes, an ejection temperature, a melt temperature, and a mold temperature;
(2) for each layering scheme, solving a heat transfer equation by using a finite difference method, calculating a cooling temperature field of each injection layer, and ascertaining a cooling time of each injection layer;
(3) obtaining a relationship model of a cooling time of a single layer and a layering scheme by fitting based on ascertained results from step (2);
(4) according to the relationship model, with an objective of minimizing a sum of cooling times of all layers and a constraint condition of a total thickness of a product, optimizing a layering scheme of the product by using a Lagrange multiplier method; and
(5) controlling, according to an optimized layering scheme, an injection molding machine to inject the material into the mold in a manner of multilayer injection molding to obtain a final product.

According to the optimization method of the present disclosure, a calculation method for an initial temperature field is proposed by means of a heat transfer model of a multilayer injection-molded product, and the cooling time of each injection layer under a given product shape and different layering schemes is ascertained by using a numerical method. A quantitative relationship of a cooling time of a single layer and a layering scheme is obtained by fitting. Finally, a layering scheme of multilayer injection molding that minimizes a molding cycle is calculated by using a Lagrange multiplier method. The production efficiency is improved and the production cost is saved.

With increasing thickness of an injection-molded product, the assumption of one-dimensional heat transfer that traditional cooling time calculation is in accordance with is no longer applicable. In addition to a thickness direction, heat dissipation in a flow direction (i.e., on a side of the product) must be taken into consideration. For a multilayer injection-molded thick-walled product, assuming that a thickness of the product is consistent at various positions, a thickness direction thereof is x direction, and a direction in which the product has the smallest radial (perpendicular to the x direction) size is y direction. Thus an internal heat transfer of the product may be regarded as a two-dimensional problem. A heat transfer equation may be written in the following formula:

$$\frac{\partial T}{\partial t} = a ( \frac{{\partial }^{2} T}{\partial {x}^{2}} + \frac{{\partial }^{2} T}{\partial {y}^{2}} ) \qquad ( 1 )$$

where T represents a real-time temperature of the product, and t represents a cooling time.
α=λ(T)/ρ(T)cₚ(T) represents a thermal diffusion coefficient of a material; λ(T) represents a thermal conductivity of the material at a temperature T; ρ(T) represents a density of the material at the temperature T; and cₚ(T) represents a specific heat of the material at the temperature T.

Preferably, in step (2), the heat transfer equation is solved by using the finite difference method within the following boundaries:

$$\{ \begin{matrix}0 \leq t \leq {T}_{eject} \\ 0 \leq x \leq D \\ 0 \leq y \leq r\end{matrix} \qquad ( 2 )$$

where t represents a direction of time; T_{eject} represents the ejection temperature; x represents a thickness direction of the product, with origin O thereof being defined as a face of the product that coincides with a stationary mold; D represents the total thickness of the product; y represents a direction which is perpendicular to the thickness direction and in which the product size is minimum, with origin O being defined as a face of the product that is close to an operation side of an injection molding machine; and r represents a product size in y direction.

Assuming that the mold temperature is consistent and set to T_{mold}, when the boundary condition is x=0, D or y=0, r, T=T_{mold}.

In the calculation of the cooling time, the initial temperature field of the product of multilayer injections cannot be expressed quantitatively, so an analytical solution cannot be obtained. After the completion of a filling process, a product (within the mold) which is about to cool may be regarded as being composed of two parts: a solidified product and a newly injected melt. Since the time of the filling process is relatively shorter than that of a cooling process, the temperature loss in the filling process is neglected. At this time, the initial temperature field of the solidified product may be considered as the result of cooling of the previously injected product. The newly injected melt region is regarded as being at a constant temperature, which is a set melt temperature of a heating barrel. Therefore, the distribution of the initial temperature field may be divided into two regions, as shown in FIG. 2.

Further preferably, in step (2), for any layering scheme, the specific process for solving a heat transfer equation by using a finite difference method specifically includes:
1) taking any newly injected melt as a current layer and a product in a mold as a current product, and discretizing the current product separately in x, y, and t directions; and defining an initial condition as an initial temperature field of combination of a melt temperature of the current layer and the solidified product, and a boundary condition is the mold temperature;
2) continuously iterating a temperature at each position discrete point on the current product at each time discrete point in sequence until a time discrete point tₖ where a maximum temperature of the current product is lower than the ejection temperature. At this point, a temperature field of the current product is the cooling temperature field of the current layer and used as the initial temperature field of the solidified product for injection of next layer. The corresponding time discrete point tₖ is the cooling time for injection of the current layer; and
3) traversing each newly injected melt in sequence, calculating the cooling temperature field of each layer, and obtaining the cooling time taken by injection of each layer.

Still further preferably, in step 1), the current product is discretized separately in the x, y, and t directions to obtain:

$$\{ \begin{matrix}{x}_{i} = i h \\ {y}_{j} = j h \\ {t}_{k} = k τ\end{matrix}$$

where xᵢ, yⱼ, and tₖ represent discrete point coordinates in three directions of a solution space, respectively; h represents a discretization step size in the x and y directions; τ represents a discretization step size in the t direction; i, j, and k represent numbers of iterations, respectively; and

$$i ∈ [ 0 , \frac{D}{h} ] ; j ∈ [ 0 , \frac{r}{h} ] ; and k ∈ [ 0 , ∞ ] .$$

Further preferably, in step 2), an iteration formula for continuously iterating a temperature at any position discrete point (xᵢ, yⱼ) on the current product at each time discrete point in sequence is as follows:

$${T}_{i , j , k + 1} = ( 1 - 4 α ) 2 {T}_{i , j , k} + α ( {T}_{i + 1 , j , k} + {T}_{i - 1 , j , k} + {T}_{i , j + 1 , k} + {T}_{i , j - 1 , k} )$$

where T_{i,j,k} represents the temperature at (xᵢ, yⱼ) at a discrete time tₖ; and at this time,

$$i ∈ [ 1 , \frac{D}{h} ] ; j ∈ [ 1 , \frac{r}{h} ] ;$$

$$α = \frac{τ a}{{h}^{2}}$$

where α represents the thermal diffusion coefficient of the material.

To ascertain the temperature field of the product at each time in the cooling process, a continuous three-dimensional space composed of x, y, and t is defined as a solution space for this problem, and the space may be discretized as:

$$\{ \begin{matrix}{x}_{i} = i h \\ {y}_{j} = j h \\ {t}_{k} = k τ\end{matrix} \qquad ( 3 )$$

where xᵢ, yⱼ, and tₖ represent discrete point coordinates in three directions of the solution space, respectively; h and z represent discretization step sizes; and i, j, and k represent numbers of iterations, respectively.

At the node (xᵢ, yⱼ, tₖ) of the solution space, the following formulas may be derived:

$${\frac{{\partial }^{2} T ( x , y , t )}{\partial {x}^{2}} \vert}_{{x}_{i} , {t}_{k}} = \frac{T ( {x}_{i} + h , {y}_{j} , {t}_{k} ) - 2 T ( {x}_{i} , {y}_{j} , {t}_{k} ) + T ( {x}_{i} - h , {y}_{j} , {t}_{k} )}{{h}^{2}} = \frac{{T}_{i + 1 , j , k} - 2 {T}_{i , j , k} + {T}_{i - 1 , j , k}}{{h}^{2}} \qquad ( 4 )$$

$${\frac{{\partial }^{2} T ( x , y , t )}{\partial {y}^{2}} \vert}_{{x}_{i} , {t}_{k}} = \frac{T ( {x}_{i} , {y}_{j} + h , {t}_{k} ) - 2 T ( {x}_{i} , {y}_{j} , {t}_{k} ) + T ( {x}_{i} , {y}_{j} - h , {t}_{k} )}{{h}^{2}} = \frac{{T}_{i , j + 1 , k} - 2 {T}_{i , j , k} + {T}_{i , j - 1 , k}}{{h}^{2}} \qquad ( 5 )$$

$${\frac{\partial T ( x , y , t )}{\partial t} \vert}_{{x}_{i} , {t}_{k}} \approx \frac{u ( {x}_{i} , {y}_{j} , {t}_{k} + τ ) - u ( {x}_{i} , {y}_{j} , {t}_{k} )}{τ} = \frac{{u}_{i , j , k + 1} - {u}_{i , j , k}}{τ} \qquad ( 6 )$$

where T(xᵢ, yⱼ, tₖ) represents the temperature at the node (xᵢ, yⱼ, tₖ) within the solution space, i.e., the temperature after cooling for time tₖ at (xᵢ, yⱼ) within the product.

The formulas (4) to (6) may be substituted into the formula (1) to derive:

$$\frac{{T}_{i , j , k + 1} - {T}_{i , j , k}}{τ} = \frac{a}{{h}^{2}} ( {T}_{i + 1 , j , k} - 2 {T}_{i , j , k} + {T}_{i - 1 , j , k} + {T}_{i , j + 1 , k} - 2 {T}_{i , j , k} + {T}_{i , j - 1 , k} ) \qquad ( 7 )$$

The iteration process of the temperature field in the cooling process is as follows:

$${T}_{i , j , k + 1} = ( 1 - 4 α ) 2 {T}_{i , j , k} + α ( {T}_{i + 1 , j , k} + {T}_{i - 1 , j , k} + {T}_{i , j + 1 , k} + {T}_{i , j - 1 , k} ) where α = \frac{τ a}{{h}^{2}} . \qquad ( 8 )$$

By the above iteration process, the temperature field evolution in the cooling process may be ascertained.

When max(Tₙ(tₖ))<T_{eject}, i.e., the maximum temperature (max(Tₙ(tₖ))) of the current product is below the set ejection temperature (T_{eject}), the current iteration time tₖ is taken as the cooling time for injection of the current layer, and the temperature field (the cooling temperature field of the current layer) distribution of the current product is used as the initial temperature field for next iteration. Thus, the suitable cooling time for each layer in multilayer injections is obtained.

Generally speaking, the cooling time is mostly correlated with a layering scheme. With a given layering scheme, the melt temperature and the mold temperature are set, by ascertaining the cooling temperature fields layer by layer, the cooling time tₙ for each injection under the particular layering scheme may be obtained.

To optimize a layering scheme of a certain product to realize a shortest molding cycle, a quantitative expression of a cooling time and the layering scheme needs to be obtained first.

Preferably, in step (3), the relationship model of a cooling time of a single layer and a layering scheme obtained by fitting is as follows:

$${t}_{n} = t ( {d}_{n} ) = f ( {d}_{1} , {d}_{2} , … {d}_{n - 1} , {d}_{n} ) \qquad ( 9 )$$

where tₙ represents the cooling time for injection of an nth layer; dₙ represents a thickness of the nth layer, n∈[1, N], N representing a total number of layers; and f(d₁, d₂, . . . dₙ₋₁, dₙ) represents an expression about the layering scheme, which is obtained by fitting cooling time results under different layering schemes and mainly related to material properties and a product shape.

Preferably, in step (4), an expression for optimizing the layering scheme of the product by using the Lagrange multiplier method is as follows:

$$\{ \begin{matrix}min {t}_{s u m} = {\sum }_{n = 1}^{N} t ( {d}_{n} ) \\ t ( {d}_{n} ) = f ( {d}_{1} , {d}_{2} , … , {d}_{n} ) \\ {D}_{n} = {\sum }_{1}^{N} {d}_{n} \\ s . t . {\sum }_{1}^{N} {d}_{n} = D\end{matrix} \qquad ( 10 )$$

where t(dₙ) represents the cooling time for injection of the nth layer; N represents the total number of layers; d₀ represents the thickness of the nth layer; f(d₁, d₂, . . . dₙ₋₁, dₙ) represents the expression about the layering scheme, which is obtained by fitting the cooling time results under different layering schemes and mainly related to the material properties and the product shape; Dₙ represents a thickness of the product in the mold; and D represents the total thickness of the product.

A Lagrangian function is established as follows:

$$L ( {d}_{1} , {d}_{2} , … , {d}_{N} ) = {\sum }_{1}^{N} t ( {d}_{n} ) + μ ( {\sum }_{1}^{N} {d}_{n} - D ) \qquad ( 11 )$$

where μ is a newly introduced parameter, which is referred to as a Lagrange multiplier.

A partial derivative of the Lagrangian function may be ascertained as follows:

$$\{ \begin{matrix}\frac{\partial L}{\partial {d}_{1}} = {\sum }_{1}^{N} \frac{\partial {t}_{n}}{\partial {d}_{1}} + μ = 0 \\ \frac{\partial L}{\partial {d}_{2}} = {\sum }_{1}^{N} \frac{\partial {t}_{n}}{\partial {d}_{2}} + μ = 0 \\ … \\ \frac{\partial L}{\partial {d}_{N}} = {\sum }_{1}^{N} \frac{\partial {t}_{n}}{\partial {d}_{N}} + μ = 0 \\ \frac{\partial L}{\partial μ} = {\sum }_{1}^{N} {d}_{n} - D = 0\end{matrix} \qquad ( 12 )$$

For the coupling influence of a thickness of each layer on a total cooling time, only a quadratic term is considered, and a higher order term with the thickness of each layer affecting the cooling time is neglected. That is, t(dₙ)=f(d₁, d₂, . . . , dₙ) is a quadratic function at most, and the formula (12) is a system of linear equations.

The formula (12) may be solved to obtain a layer thickness distribution d(n) under different numbers of layers and the Lagrange multiplier y that are related to the number N of layers and minimize the cooling time. The layer thickness distribution is an optimum layer thickness needing to be injected each time.

Considering that in addition to the cooling time, there are other fixed time St in a cycle of multilayer injection molding, including a machine operation time, a total molding cycle may be expressed as:

$${t}_{fnl} = {\sum }_{1}^{N} d ( n ) + N δ t \qquad ( 13 )$$

As can be seen, under the condition of the known optimum layer thickness distribution d(n), the final molding cycle expression (13) is merely a function of the total number N of layers. A minimum value of the formula (13) may be ascertained to obtain a number of multilayer injection layers that minimizes the molding cycle, thereby obtaining an optimized complete layering scheme including the number of layers and the thickness of each layer. The multilayer injection molding may be carried out by an injection molding machine which is controlled according to the optimized complete layering scheme to inject melt into the mold to obtain a final product.

Compared with the prior art, the present disclosure has the following beneficial effects:

The optimization method for a layering scheme of multilayer injection molding of the present disclosure includes: solving the heat transfer equation by using the finite difference method to obtain the cooling time for injection of each layer under different layering schemes, and obtaining the relationship model of the cooling time of the single layer and the layering scheme by fitting; and finally, with the objective of minimizing cooling times of all injection layers and the total thickness of the product as the constraint condition, optimizing the layering scheme of the product by using the Lagrange multiplier method. Through optimization by the method of the present disclosure, an optimized layering scheme can be obtained, allowing for an effectively shortened injection molding cycle, a reduced production cost, and improved product quality.

### BRIEF DESCRIPTION OF THE DRAWINGS

FIG. 1 is a flowchart of ascertaining a cooling time of each injection layer in an embodiment of the present disclosure;

FIG. 2 illustrates setting of an initial temperature field for cooling of multilayer injection molding;

FIG. 3A is a schematic diagram of different injection directions of multilayer injection molding; FIG. 3B is a comparison diagram of cooling temperature fields in different injection directions ascertained in an embodiment of the present disclosure; and FIG. 3C is a comparison diagram of cooling temperature fields in different injection directions ascertained by commercial mold flow analysis software Moldex3D;

FIG. 4 is a three-dimensional diagram of fitting of cooling time results of each injection layer under different layering schemes ascertained in an embodiment of the present disclosure; and

FIG. 5A is a chart of a changing trend of a cooling time with a solidified thickness; and FIG. 5B is a chart of a changing trend of a cooling time with a current injection molding thickness.

### DETAILED DESCRIPTION

To provide a clearer understanding of the present disclosure, the present disclosure is further described below according to specific examples and drawings of the present disclosure.

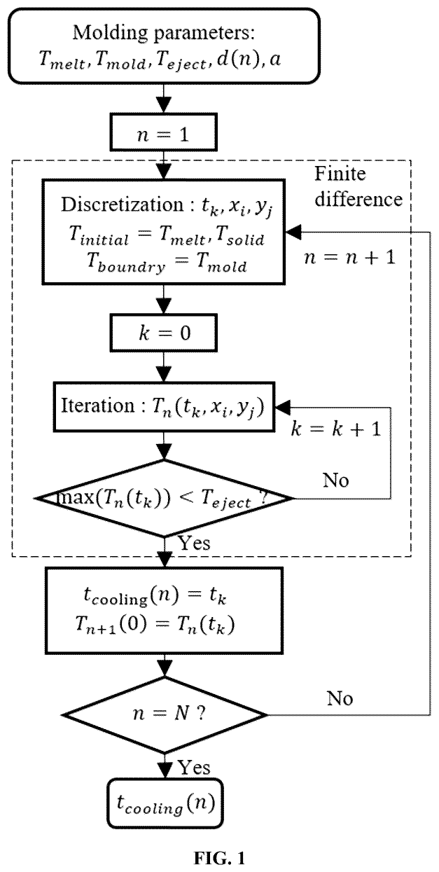

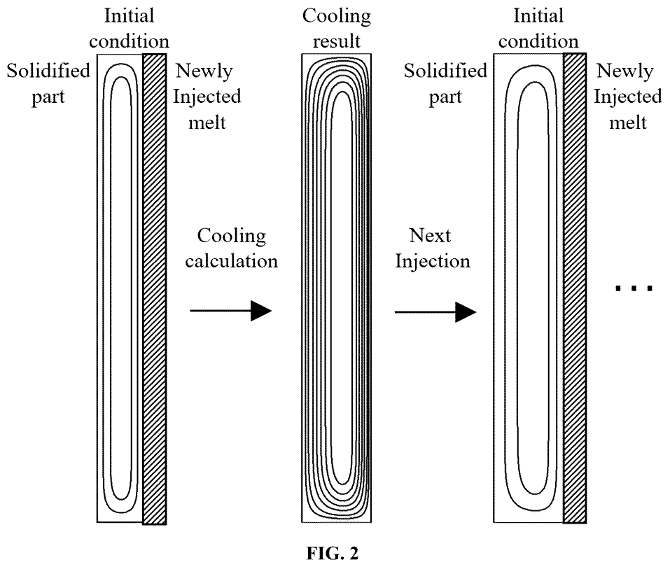

As shown in FIG. 1, an optimization method for a layering scheme of multilayer injection molding includes the following steps.

(1) A product size, a thermal diffusion coefficient of a material, a plurality of layering schemes, an ejection temperature, a melt temperature, and a mold temperature are input.

The thermal diffusion coefficient α of the material is as follows:

$$a = λ ( T ) / ρ ( T ) {c}_{p} ( T )$$

λ(T) represents a thermal conductivity of the material at a temperature T; ρ(T) represents a density of the material at the temperature T; and cₚ(T) represents a specific heat of the material at the temperature T. Here, the plurality of layering schemes refer to as many layering schemes as possible under a same product size, i.e., each including the total number of layers and the thickness of each layer. The ejection temperature T_{eject}, the melt temperature Tₘₑₗₜ, and the mold temperature T_{mold} are obtained by setting.

(2) For each layering scheme, a heat transfer equation is solved by using a finite difference method, a cooling temperature field of each injection layer is calculated, and a cooling time of each injection layer is ascertained.

For a multilayer injection-molded thick-walled product, assuming that the thickness of the product is consistent at various positions, the thickness direction thereof is x direction, and the direction in which the radial size is minimal, internal heat transfer of the product may be regarded as the two-dimensional problem. The heat transfer equation may be written in the following formula:

$$\frac{\partial T}{\partial t} = a ( \frac{{\partial }^{2} T}{\partial {x}^{2}} + \frac{{\partial }^{2} T}{\partial {y}^{2}} ) \qquad ( 1 )$$

where T represents a real-time temperature of the product, and t represents a cooling time.

The heat transfer equation is solved by using the finite difference method within the following boundaries:

$$\{ \begin{matrix}0 \leq t \leq {T}_{eject} \\ 0 \leq x \leq D \\ 0 \leq y \leq r\end{matrix} \qquad ( 2 )$$

where t represents a direction of time; T_{eject} represents the ejection temperature; x represents a thickness direction of the product, with origin O thereof being defined as a face of the product that coincides with a stationary mold; D represents the total thickness of the product; y represents a direction which is perpendicular to the thickness direction and in which the product size is minimum, with origin O being defined as a face of the product that is close to an operation side of an injection molding machine; and r represents a product size in y direction.

Assuming that the mold temperature is consistent and set to T_{mold}, when the boundary condition is x=0, D or y=0, r, T=T_{mold}.

For any layering scheme, the solving a heat transfer equation by using a finite difference method specifically includes the following process.
1) Any newly injected melt is taken as a current layer and a product in a mold as a current product, and the current product is discretized separately in x, y, and t directions; and an initial condition Tᵢₙᵢₜᵢₐₗ is defined as a combination of a melt temperature Tₘₑₗₜ of the current layer and an initial temperature field T_{solid} of the solidified product, and a boundary condition T_{boundry} is defined as the mold temperature T_{mold}.
2) A temperature at each position discrete point on the current product at each time discrete point is continuously iterated in sequence until a time discrete point tₖ where a maximum temperature max(Tₙ(tₖ)) of the current product is lower than the ejection temperature T_{eject}, where a temperature field of the current product at this time is the cooling temperature field of the current layer and used as the initial temperature field of the solidified product for injection of next layer, and the corresponding time discrete point tₖ is the cooling time for injection of the current layer.
3) Each newly injected melt is traversed in sequence, the cooling temperature field of each layer is calculated, and the cooling time taken by injection of each layer is obtained.

To ascertain the temperature field of the product at each time in the cooling process, a continuous three-dimensional space composed of x, y, and t is defined as a solution space for this problem, and the space may be discretized as:

$$\{ \begin{matrix}{x}_{i} = ih \\ {y}_{j} = jh \\ {t}_{k} = k τ\end{matrix} \qquad ( 3 )$$

where xᵢ, yⱼ, and tₖ represent discrete point coordinates in three directions of the solution space, respectively; h and z represent discretization step sizes; i, j, and k represent numbers of iterations, respectively; and

$$i ∈ [ 0 , \frac{D}{h} ] ; j ∈ [ 0 , \frac{r}{h} ] ; and k ∈ [ 0 , ∞ ] .$$

At the node (xᵢ, yⱼ, tₖ) of the solution space, the following formulas may be derived:

$${\frac{{\partial }^{2} T ( x , y , t )}{\partial {x}^{2}} \vert}_{{x}_{i} , {t}_{k}} = \frac{T ( {x}_{i} + h , {y}_{j} , {t}_{k} ) - 2 T ( {x}_{i} , {y}_{j} , {t}_{k} ) + T ( {x}_{i} - h , {y}_{j} , {t}_{k} )}{{h}^{2}} = \frac{{T}_{i + 1 , j , k} - 2 {T}_{i , j , k} + {T}_{i - 1 , j , k}}{{h}^{2}} \qquad ( 4 )$$

$${\frac{{\partial }^{2} T ( x , y , t )}{\partial {y}^{2}} \vert}_{{x}_{i} , {t}_{k}} = \frac{T ( {x}_{i} , {y}_{j} + h , {t}_{k} ) - 2 T ( {x}_{i} , {y}_{j} , {t}_{k} ) + T ( {x}_{i} , {y}_{j} - h , {t}_{k} )}{{h}^{2}} = \frac{{T}_{i , j + 1 , k} - 2 {T}_{i , j , k} + {T}_{i , j - 1 , k}}{{h}^{2}} \qquad ( 5 )$$

$${\frac{\partial T ( x , y , t )}{\partial t} \vert}_{{x}_{i} , {t}_{k}} \approx \frac{u ( {x}_{i} , {y}_{j} , {t}_{k} + τ ) - u ( {x}_{i} , {y}_{j} , {t}_{k} )}{τ} = \frac{{u}_{i , j , k + 1} - {u}_{i , j , k}}{τ} ; \qquad ( 6 )$$

and
where T(xᵢ, yⱼ, tₖ) represents the temperature at the node (xᵢ, yⱼ, tₖ) within the solution space, i.e., the temperature after cooling for time tₖ at (xᵢ, yⱼ) within the product.

The formulas (4) to (6) may be substituted into the formula (1) to derive:

$$\frac{{T}_{i , j , k + 1} - {T}_{i , j , k}}{τ} = \frac{a}{{h}^{2}} ( {T}_{i + 1 , j , k} - 2 {T}_{i , j , k} + {T}_{i - 1 , j , k} + {T}_{i , j + 1 , k} - 2 {T}_{i , j , k} + {T}_{i , j - 1 , k} ) \qquad ( 7 )$$

The iteration process of the temperature field in the cooling process is as follows:

$${T}_{i , j , k + 1} = ( 1 - 4 α ) 2 {T}_{i , j , k} + α ( {T}_{i + 1 , j , k} + {T}_{i - 1 , j , k} + {T}_{i , j + 1 , k} + {T}_{i , j - 1 , k} ) \\ where α = \frac{τ a}{{h}^{2}} . \qquad ( 8 )$$

By the above iteration process, the temperature field evolution in the cooling process may be ascertained.

(3) A relationship model of a cooling time of a single layer and a layering scheme is obtained by fitting based on ascertained results from step (2). An expression of the relationship model is as follows:

$${t}_{n} = t ( {d}_{n} ) = f ( {d}_{1} , {d}_{2} , … {d}_{n - 1} , {d}_{n} ) \qquad ( 9 )$$

where tₙ represents the cooling time for injection of an nth layer; dₙ represents a thickness of the nth layer, n∈[1, N], N representing a total number of layers; and f(d₁, d₂, . . . dₙ₋₁, dₙ) represents an expression about the layering scheme, which is obtained by fitting cooling time results under different layering schemes and mainly related to material properties and a product shape.

(4) According to the relationship model, with an objective of minimizing a sum of cooling times of all layers and a constraint condition of a total thickness of a product, a layering scheme of a given product is optimized by using a Lagrange multiplier method.

An expression for optimizing the layering scheme of the product by using the Lagrange multiplier method is as follows:

$$\{ \begin{matrix}min {t}_{sum} = {\sum }_{n = 1}^{N} t ( {d}_{n} ) \\ t ( {d}_{n} ) = f ( {d}_{1} , {d}_{2} , … , {d}_{n} ) \\ {D}_{n} = {\sum }_{1}^{n} {d}_{n} \\ s . t . {\sum }_{1}^{N} {d}_{n} = D\end{matrix} \qquad ( 10 )$$

where t(dₙ) represents the cooling time for injection of the nth layer; N represents the total number of layers; dₙ represents the thickness of the nth layer; f(d₁, d₂, . . . dₙ₋₁, dₙ) represents the expression about the layering scheme, which is obtained by fitting the cooling time results under different layering schemes and mainly related to the material properties and the product shape; Dₙ represents a thickness of the product in the mold; and D represents the total thickness of the product.

A Lagrangian function is established as follows:

$$L ( {d}_{1} , {d}_{2} , … , {d}_{N} ) = {\sum }_{1}^{N} t ( {d}_{n} ) + μ ( {\sum }_{1}^{N} {d}_{n} - D ) \qquad ( 11 )$$

where μ is a newly introduced parameter, which is referred to as a Lagrange multiplier.

A partial derivative of the Lagrangian function may be ascertained as follows:

$$\{ \begin{matrix}\frac{\partial L}{\partial {d}_{1}} = {\sum }_{1}^{N} \frac{\partial {t}_{n}}{\partial {d}_{1}} + μ = 0 \\ \frac{\partial L}{\partial {d}_{2}} = {\sum }_{1}^{N} \frac{\partial {t}_{n}}{\partial {d}_{2}} + μ = 0 \\ … \\ \frac{\partial L}{\partial {d}_{N}} = {\sum }_{1}^{N} \frac{\partial {t}_{n}}{\partial {d}_{N}} + μ = 0 \\ \frac{\partial L}{\partial μ} = {\sum }_{1}^{N} {d}_{n} - D = 0\end{matrix} \qquad ( 12 )$$

For the coupling influence of a thickness of each layer on a total cooling time, only a quadratic term is considered, and a higher order term with the thickness of each layer affecting the cooling time is neglected. That is, t(dₙ)=f(d₁, d₂, . . . , dₙ) is a quadratic function at most, and the formula (12) is a system of linear equations.

The formula (12) may be solved to obtain a layer thickness distribution d(n) under different numbers of layers and the Lagrange multiplier y that are related to the number N of layers and minimize the cooling time. The layer thickness distribution is a layer thickness needing to be injected each time.

Considering that in addition to the cooling time, there are other fixed time St in a cycle of multilayer injection molding, including a machine operation time in addition to the cooling time, a total molding cycle may be expressed as:

$${t}_{fnl} = {\sum }_{1}^{N} d ( n ) + N δ t \qquad ( 13 )$$

As can be seen, under the condition of the known optimum layer thickness distribution d(n), the final molding cycle expression (13) is merely a function of the total number N of layers. A minimum value of the formula (13) may be ascertained to obtain a number of multilayer injection molding layers that minimizes the molding cycle, thereby obtaining an optimized complete layering scheme including the number of layers and the thickness of each layer.

The influence of different injection directions on product cooling is studied below by using the above optimization method.

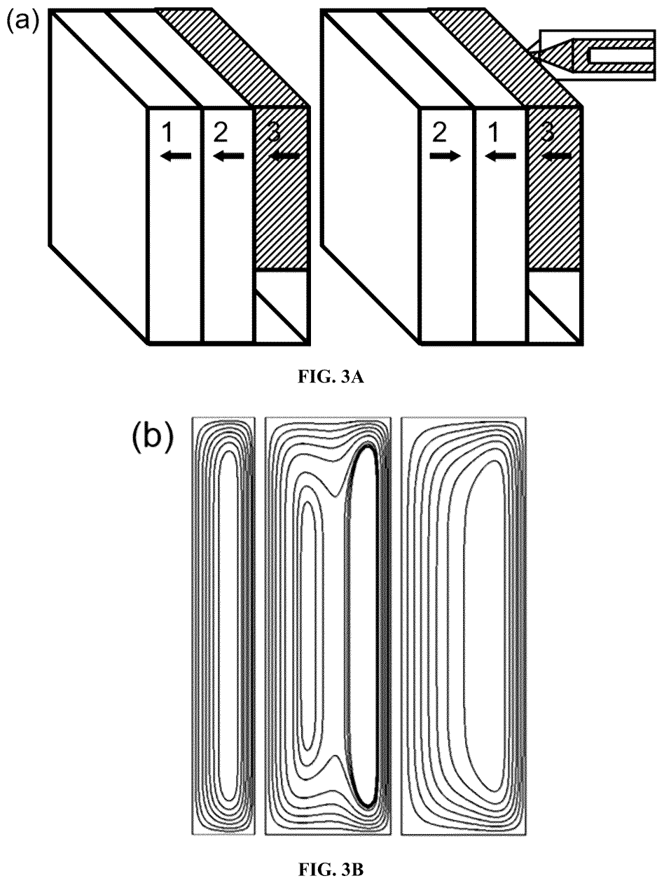

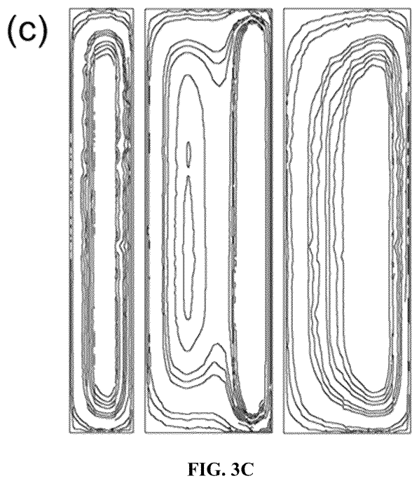

Unlike additive manufacturing, the molding time of each layer of multilayer injection molding is relatively long. If the melt is injected from one direction and stacked, the temperature field in the thickness direction may be caused to be asymmetric, thus affecting the performance of the final product. Therefore, the influence of the injection direction needs to be considered. To eliminate this influence, the molded product is reversed at each injection, and the melt is stacked from different directions at each injection. FIG. 3A shows injection directions of multilayer injection molding, including unidirectional injection and bidirectional injection. Bidirectional injection may prevent product heat from accumulation in one direction, thereby facilitating heat dissipation and shortening the cooling time.

A polymethyl methacrylate (PMMA) material is used for injection, and the heat transfer equation is solved by using the above finite difference method to calculate the cooling temperature field of each layer, and the calculated typical temperature field of the product after being ejected from the mold is as shown in FIG. 3B. The thickness of each injection is 5 mm, and a square product having a 100*100 mm section is finally molded. As shown in FIG. 3B, from left to right, 3 layers (a total thickness of 15 mm) are injected unidirectionally, 6 layers are injected bidirectionally, and 6 layers (a total thickness of 30 mm) are injected unidirectionally. In the first several injection processes, the thickness of the molded product is small, and a high temperature region occurs in the middle of the product. In next injection, the heat of the melt is transferred to the high temperature region of the product, and residual heat of the solidified part is concentrated in the region, leading to a prolonged cooling time. When the molding thickness gradually increases, since each injection direction is different, two high temperature regions occur, which are distributed on two sides of the thickness of the product. Therefore, the cooling efficiency of the product is higher on two sides, and the cooling time of each injection cycle may also be shortened. However, for unidirectional injection, as shown in FIG. 3B (the leftmost side), there is only one high temperature region. This may lead to difficult cooling and a prolonged cooling time. This also indicates that the melt should be injected from two directions in order to shorten the cooling time. The different injection directions are simulated by using the commercial mold flow analysis software (Moldex3D), and the results are consistent with those of the optimization method, as shown in FIG. 3C.

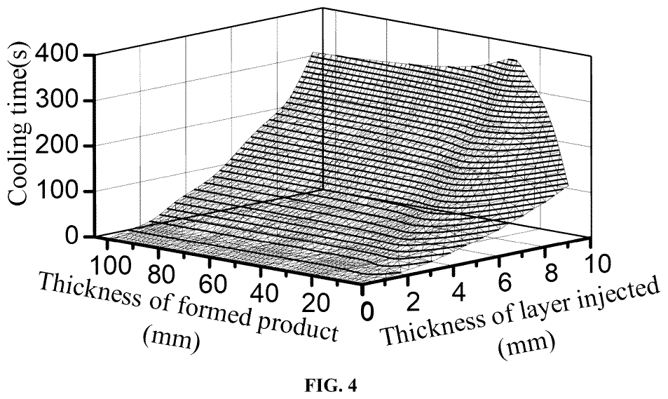

Based on an assumption that the layering scheme of each injection involves a same layer thickness, the molding cycle of a bidirectional injection-molded PMMA product is calculated by using the above optimization method. The cross-section of the product is a 100 mm×100 mm rectangle. The boundary condition is set as the mold temperature T_{mold}=75° C., and the initial condition is divided into two parts: the solidified product and the newly injected product, as described above. The temperature of the currently injected melt is Tₘₑₗₜ=240° C., and the temperature of the solidified part is the result of cooling calculation after previous injection. The thickness range of the current layer is set to 0-10 mm, and the thickness of the solidified layer is set to 0-100 mm. Exhaustive iteration is carried out within this range. By continuous updating in iterations, the cooling time for injection of each layer under different layering schemes is obtained. The calculated results are fitted as a three-dimensional surface, as shown in FIG. 4.

According to the fitting result, the cooling time may be found out rapidly when the layering scheme is given. A specific process is as follows.

The thickness of a first layer is determined as d₁ and a molded thickness as 0, and the cooling time of the first layer may be found out. The thickness of a second layer is determined as d₂ and the molded thickness as d₁, and the cooling time of the second layer may be found out. The thickness of a third layer is determined as d₃ and the molded thickness as d₁+d₂, and the cooling time of the third layer may be found out. The thickness of the nth layer is determined as dₙ and the molded thickness as Σ₁ⁿ⁻¹dₙ, and the cooling time of the nth layer may be found out. After all the injection layers are calculated, the cooling time tₙ for the multilayer injection-molded product at each molding is obtained.

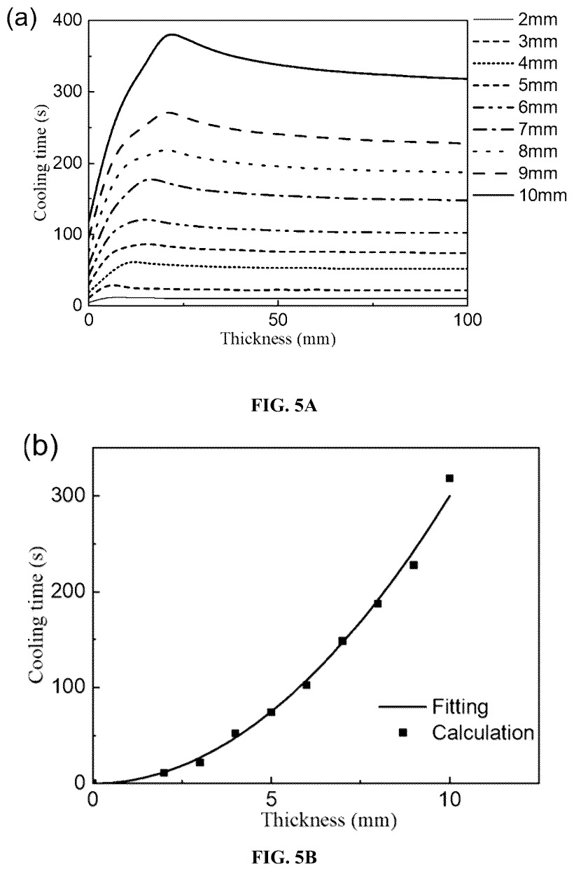

As shown in FIG. 5A, a relationship between a thickness of an injection layer (the thickness of the solidified layer) and a cooling time is studied. As can be seen, as the thickness of the molded product (the solidified part) increases, the desired cooling time increases firstly and then decreases. When the thickness of the molded layer is far greater than that of the current injection layer, the cooling time finally tends to be stable. It can also be observed from FIG. 5A, when the thickness of the molded product is small, the cooling time of a single injection is the longest. In other words, the cooling times of the first several injections are the longest. A limit cooling time for a different layer thickness (the thickness of the current injection layer) is studied, as shown in FIG. 5B. As can be seen, there is a quadratic relationship between the cooling time and the injection thickness of a single layer, i.e., t(d)=k₁d², and a coefficient k₁=3.007 is obtained by fitting.

Table 1 shows comparison between times required to calculate cooling temperature fields by the commercial software Moldex3D and the optimization method of this embodiment. The optimization method of this embodiment is significantly superior in efficiency to the existing commercial mold flow analysis software Moldex3D. Compared with the commercial software Moldex3D, the optimization method of this embodiment may greatly reduce the cooling temperature field calculation time, which is of great significance in practical production.

TABLE 1
Comparison Between Times Required to Calculate
Cooling Temperature Fields by the Method of the
Present Disclosure and the Commercial Software

| Calculation | | | | | | | | |
|---|---|---|---|---|---|---|---|---|
| Method | First layer | | Third layer | | Fifth layer | | Seventh layer | |
| Method of the | <0.1 | s | <0.1 | s | <0.1 | s | <0.1 | s |
| present disclosure | | | | | | | | |
| Commercial | 2013 | s | 3124 | s | 3817 | s | 3923 | s |
| software | | | | | | | | |

On this basis, the layering scheme is optimized to obtain the shortest molding cycle. The optimization problem of minimizing an overall cooling time is as follows: where tₛᵤₘ represents the overall cooling time in the whole molding cycle.

$$\{ \begin{matrix}min {t}_{s u m} = {\sum }_{1}^{N} t ( {d}_{n} ) \\ t ( d ) = {k}_{1} {d}^{2} \\ s . t . {\sum }_{1}^{N} {d}_{n} = D\end{matrix} \qquad ( 14 )$$

where dₙ represents an injection molding layer thickness of the nth layer, and Nis the total number of layers molded.

A Lagrangian function is established as follows:

$$L ( {d}_{1} , … , {d}_{N} ) = {\sum }_{1}^{N} t ( {d}_{n} ) + μ ( {\sum }_{1}^{N} {d}_{n} - D ) \qquad ( 15 )$$

where μ is a newly introduced parameter, which is referred to as a Lagrange multiplier.

A partial derivative of the formula (15) may be ascertained as follows:

$$\{ \begin{matrix}\frac{\partial L}{\partial {d}_{1}} = 2 {k}_{1} {d}_{1} + μ = 0 \\ \frac{\partial L}{\partial {d}_{2}} = 2 {k}_{1} {d}_{2} + μ = 0 \\ … \\ \frac{\partial L}{\partial {d}_{N}} = 2 {k}_{1} {d}_{N} + μ = 0 \\ \frac{\partial L}{\partial μ} = {\sum }_{1}^{N} {d}_{n} - D = 0\end{matrix} \qquad ( 16 )$$

The formula (16) may be solved to obtain:

$${d}_{1} = {d}_{2} = … {d}_{N} = D / N \qquad ( 17 )$$

According to the above results, under a given number of injections, to achieve the shortest molding cycle, it needs to keep the melt thickness of each injection identical.

On this basis, the number of layers is optimized, and the total time of the molding cycle is expressed as:

$${t}_{f n l} = N ( {k}_{1} {d}^{2} + δ t ) \qquad ( 18 )$$

In consideration of D=Nd, the number of layers that minimizes t_{fnl} may be easily obtained as:

$$N = D \sqrt{\frac{{k}_{1}}{δ t}} \qquad ( 19 )$$

For a product having a total thickness D=30 mm, the fixed time of each injection obtained by experiment is about δt=75 s. A scale factor k₁ is as shown in FIG. 5(b), and fitting is performed to obtain k₁=3.007, and the optimal number of layers is N≈6. The times of multilayer injection molding cycles of products having different numbers of layers obtained by injection molding experiments are shown in Table 2.

TABLE 2
Molding Cycles of Products Having Different
Numbers of Layers Obtained by Experiments

| Total | | | | |
|---|---|---|---|---|
| Number | | | | |
| of Layers | 3 Layers | 6 Layers | 9 Layers | 12 Layers |
| Molding | 17.66 ± 0.58 | 14.33 ± 0. 58 | 16.00 ± 1.00 | 19.00 ± 1.73 |
| cycle | | | | |
| (min) | | | | |

As can be seen from Table 2, the optimal number of layers that minimizes the molding cycle obtained by the injection molding experiment is 6, which is identical to the optimal number of layers calculated by the optimization method of this embodiment. This indicates that the optimization method of this embodiment can effectively optimize the layering scheme.

The foregoing is the description of one application example of the present disclosure and is not limiting of shapes and layering schemes suitable for multilayer injection-molded products. Materials measurable by using the present disclosure cannot be exhausted one by one here. Any modification, equivalent replacement, improvement, or the like made within the spirit and principle of the present disclosure shall fall within the protection scope of the present disclosure.

What is claimed is:

1. An optimization method for a layering scheme of multilayer injection molding, comprising the following steps:
(1) inputting a product size, a thermal diffusion coefficient of a material, a plurality of layering schemes, an ejection temperature, a melt temperature, and a mold temperature;
(2) for each layering scheme, solving a heat transfer equation by using a finite difference method, calculating a cooling temperature field of each injection layer, and ascertaining a cooling time of each injection layer;
(3) obtaining a relationship model of a cooling time of a single layer and a layering scheme by fitting based on ascertained results from step (2);
(4) according to the relationship model, with an objective of minimizing a sum of cooling times of all layers and a constraint condition of a total thickness of a product, optimizing a layering scheme of the product by using a Lagrange multiplier method; and
(5) controlling, according to an optimized layering scheme, an injection molding machine to inject the material into a mold in a manner of multilayer injection molding to obtain a final product.

2. The optimization method for a layering scheme of multilayer injection molding according to claim 1, wherein in step (2), the heat transfer equation is solved by using the finite difference method within the following boundaries:
$$\{ \begin{matrix}0 \leq t \leq {T}_{eject} \\ 0 \leq x \leq D \\ 0 \leq y \leq r\end{matrix}$$
wherein t represents a direction of time; T_{eject} represents the ejection temperature; x represents a thickness direction of the product, with origin O thereof being defined as a face of the product that coincides with a stationary mold; D represents the total thickness of the product; y represents a direction which is perpendicular to the thickness direction and in which the product size is minimum, with origin O being defined as a face of the product that is close to an operation side of an injection molding machine; and r represents a product size in y direction.

3. The optimization method for a layering scheme of multilayer injection molding according to claim 2, wherein in step (2), for each layering scheme, the solving a heat transfer equation by using a finite difference method specifically comprises:
1) taking any newly injected melt as a current layer and a product in a mold as a current product, and discretizing the current product separately in x, y, and t directions;
and defining an initial condition as a combination of a melt temperature of the current layer and an initial temperature field of the solidified product, and a boundary condition as the mold temperature;
2) continuously iterating a temperature at each position discrete point on the current product at each time discrete point in sequence until a time discrete point tₖ where a maximum temperature of the current product is lower than the ejection temperature, wherein a temperature field of the current product at this time is the cooling temperature field of the current layer and used as the initial temperature field of the solidified product for injection of next layer, and the corresponding time discrete point tₖ is the cooling time for injection of the current layer; and
3) traversing each newly injected melt in sequence, calculating the cooling temperature field of each layer, and obtaining the cooling time taken by injection of each layer.

4. The optimization method for a layering scheme of multilayer injection molding according to claim 3, wherein in step 1), the current product is discretized separately in the x, y, and t directions to obtain:
$$\{ \begin{matrix}{x}_{i} = i h \\ {y}_{j} = j h \\ {t}_{k} = k τ\end{matrix}$$
wherein xᵢ, yⱼ, and tₖ represent discrete point coordinates in three directions of a solution space, respectively; h represents a discretization step size in the x and y directions; T represents a discretization step size in the t direction; i, i, and k represent numbers of iterations, respectively; and
$$i ∈ [ 0 , \frac{D}{h} ] ; j ∈ [ 0 , \frac{r}{h} ] ; and k ∈ [ 0 , ∞ ] .$$

5. The optimization method for a layering scheme of multilayer injection molding according to claim 4, wherein in step 2), an iteration formula for continuously iterating a temperature at any position discrete point (xᵢ, yⱼ) on the current product at each time discrete point in sequence is as follows:
$${T}_{i , j , k + 1} = ( 1 - 4 α ) 2 {T}_{i , j , k} + α ( {T}_{i + 1 , j , k} + {T}_{i - 1 , j , k} + {T}_{i , j + 1 , k} + {T}_{i , j - 1 , k} )$$
wherein T_{i,j,k} represents the temperature at (xᵢ, yⱼ) at a discrete time tₖ; and at this time,
$$i ∈ [ 1 , \frac{D}{h} ] ; j ∈ [ 1 , \frac{r}{h} ] ;$$
$$α = \frac{τ a}{{h}^{2}}$$
wherein a represents the thermal diffusion coefficient of the material.

6. The optimization method for a layering scheme of multilayer injection molding according to claim 1, wherein in step (3), the relationship model of a cooling time of a single layer and a layering scheme obtained by fitting is as follows:
$${t}_{n} = t ( {d}_{n} ) = f ( {d}_{1} , {d}_{2} , … {d}_{n - 1} , {d}_{n} )$$
wherein tₙ represents the cooling time for injection of an nth layer; dₙ represents a thickness of the nth layer, n∈[1, N], N representing a total number of layers; and f(d₁, d₂, . . . dₙ₋₁, dₙ) represents an expression about the layering scheme, which is obtained by fitting cooling time results under different layering schemes and mainly related to material properties and a product shape.

7. The optimization method for a layering scheme of multilayer injection molding according to claim 1, wherein in step (4), an expression for optimizing the layering scheme of the product by using the Lagrange multiplier method is as follows:
$$\{ \begin{matrix}min {t}_{s u m} = {\sum }_{n = 1}^{N} t ( {d}_{n} ) \\ t ( {d}_{n} ) = f ( {d}_{1} , {d}_{2} , … , {d}_{n} ) \\ {D}_{n} = {{\sum }_{1}}^{n} {d}_{n} \\ s . t . {\sum }_{1}^{N} {d}_{n} = D\end{matrix}$$
wherein t(dₙ) represents the cooling time for injection of an nth layer; N represents the total number of layers; dₙ represents the thickness of the nth layer; f(d₁, d₂, . . . dₙ₋₁, dₙ) represents the expression about the layering scheme, which is obtained by fitting the cooling time results under different layering schemes and mainly related to the material properties and the product shape; Dₙ represents a thickness of the product in the mold; and D represents the total thickness of the product.
